(19) United States
(12) Patent Application Publication
(10) Pub. No.: US 2008/0205927 A1
(43) Pub. Date: Aug. 28, 2008

(54) XEROGRAPHIC CUSTOMER REPLACEMENT UNIT KIT

(75) Inventors: Cheryl A. Linton, Webster, NY (US); Bruce E. Thayer, Webster, NY (US)

Correspondence Address: BASCH & NICKERSON LLP, 1777 PENFIELD ROAD, PENFIELD, NY, 14526, US

(73) Assignee: Xerox Corporation, Stamford, CT (US)

(21) Appl. No.: 11/677,612

(22) Filed: Feb. 22, 2007

(51) Int. Cl. G03G 21/18

(52) U.S. Cl. 399/111

(57) ABSTRACT

A customer replaceable unit kit contains a customer replaceable unit having a xerographic component customer replaceable unit already loaded with toner and/or waste bottles and one or more additional toner bottles to extend the life of the xerographic component customer replaceable unit. The customer replaceable unit kit allows the removal and replacement of new and used toner bottles with ease and no spillage. The customer replaceable unit kit contains compartments that store and seal used bottles as the additional toner bottles are removed from the customer replaceable unit kit. The depleted customer replaceable unit kit can be shipped to a predetermined destination for remanufacturing, recycling, and/or proper disposal.

### BACKGROUND

Generally, the process of electrophotographic reproduction, as practiced in electrophotographic reproduction machines, includes charging a photoconductive member to a substantially uniform potential so as to sensitize the surface thereof. A charged portion of the photoconductive surface is exposed at an exposure station to a light image of an original document to be reproduced or from electronically generated or stored originals. Typically, an original document to be reproduced is placed in registration, either manually or by means of an automatic document handler, on a platen for such exposure.

Exposing an image of an original document at the exposure station records an electrostatic latent image of the original image onto the photoconductive member. The recorded latent image is subsequently developed using a development apparatus by bringing a charged dry or liquid developer material into contact with the latent image. Two component and single component developer materials are commonly used.

A typical two-component dry developer material has magnetic carrier granules with fusible toner material adhering triboelectrically thereto. A single component dry developer material typically has toner material only.

The toner image formed by such development is subsequently transferred at a transfer station onto a recording medium fed to the transfer station, and onto which the toner material is then heated and permanently fused so as to form a “hardcopy” of the original image.

One familiar type of development of an electrostatic image is called “two-component development” because it utilizes two-component developer. Two-component developer largely comprises toner material interspersed with carrier material. The carrier material is magnetically attractable, and the toner material is caused to adhere triboelectrically to the carrier material. This two-component developer can be conveyed by, for example, a “magnetic roll” to the electrostatic latent image, where toner material becomes detached from the carrier material and adheres as desired to the electrostatic latent image.

It is well known to provide a number of the expendable components of an electrophotographic reproduction machine in the form of a customer or user replaceable unit. Typically such units are formed as a cartridge that can be inserted or removed from the machine frame by a customer or user. Reproduction machines such as copiers and printers ordinarily include consumable materials, such as toner; volume limiting components, such as a waste toner container; and life cycle limiting components, such as a photoreceptor and a cleaning device. Since these elements of the copying machine or printer must be replaced frequently, these elements are more likely to be incorporated into a replaceable cartridge as above.

It is noted that various types and sizes of cartridges, varying from a single machine element cartridge, such as a toner cartridge, to an all-in-one electrophotographic toner image forming and transfer process cartridge. The design, particularly of an all-in-one cartridge, can be very costly and complicated due to the need to optimize the life cycles of the different elements, as well as to integrate all the included elements while not undermining the image quality. This is particularly true for all-in-one cartridges to be used in a family of compact electrophotographic reproduction machines where the toner supply is depleted before the xerographic components wear out within the cartridge.

All-in-one cartridges typically have life cycles of 2000 upwards of 25,000 prints. The useful life of an all-in-one cartridge is monitored in a number of ways, including a print counter, low toner sensor, OPC resistance measurement or simply based on image degradation. By design the longevity of an all-in-one cartridge is a direct function of the volume of toner that it contains, whereas the xerographic components usually have life cycles significantly greater than the maximum volume of available toner.

A solution to the all-in-one cartridge problems is a customer replaceable unit that allows the replacement of the toner with a fresh toner cartridge. Clearly, this increases the life of the xerographic component customer replaceable unit.

However, the actual life of the xerographic component customer replaceable unit is not generally synchronous or directly coincidental with the number of times the toner unit has been replaced, thereby causing the user to install a new toner cartridge and then potentially have the xerographic component customer replaceable unit life cycle terminated before the toner is completely used. This “out of phase” end-of-life results in the waste of toner, thereby increasing the cost of ownership because a partially used toner unit is generally not re-installable.

Therefore, it is desirable to provide an all-in-one kit containing a xerographic replaceable unit combined with the necessary number of toner cartridges, wherein the last toner cartridge is depleted concurrently with the end of life of the xerographic replaceable unit.

### BRIEF DESCRIPTION OF THE DRAWINGS

The drawings are only for purposes of illustrating an embodiment and are not to be construed as limiting, wherein:

FIG. 1 illustrates an all-in-one customer replaceable unit;

FIG. 2 illustrates a customer replaceable unit featuring replaceable toner and waste units;

FIG. 3 illustrates a schematic of a customer replaceable unit kit;

FIG. 4 illustrates a detailed drawing of a packaged customer replaceable unit kit with one end of the kit opened;

FIG. 5 graphically displays replacing the waste and toner bottles of a customer replaceable unit;

FIG. 6 illustrates a customer replaceable unit kit container with a new toner cartridge being replaced with a waste cartridge;

FIG. 7 illustrates an example of a compartment configuration for a customer replaceable unit kit corresponding to a color reprographic machine;

FIG. 8 illustrates another example of a compartment configuration for a customer replaceable unit kit corresponding to a color reprographic machine.

### DETAILED DESCRIPTION

For a general understanding, reference is made to the drawings. In the drawings, like references have been used throughout to designate identical or equivalent elements. It is also noted that the drawings may not have been drawn to scale and that certain regions may have been purposely drawn disproportionately so that the features and concepts could be properly illustrated.

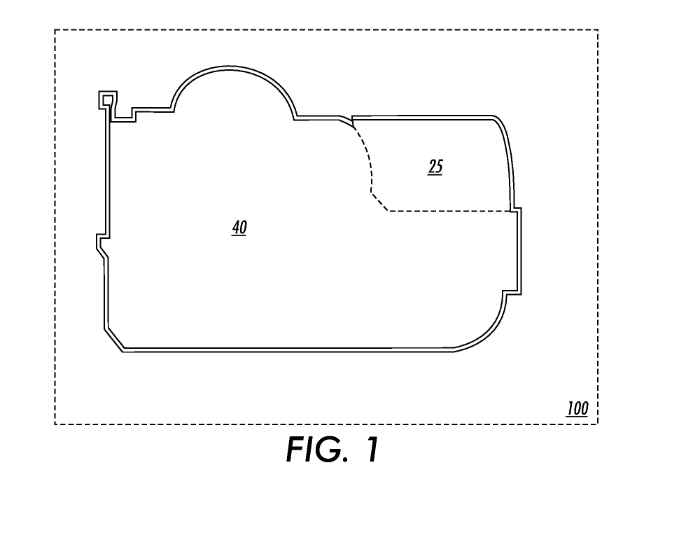

As noted above, it is desirable to provide an all-in-one customer replaceable unit support kit for an electrophotographic reproduction machine which eliminates the possibility of un-usable toner thereby reducing the cost of ownership while maximizing the life cycle of the xerographic components. A schematic of an all-in-one customer replaceable unit 100 is shown in FIG. 1. The all-in-one customer replaceable unit 100 includes toner hopper 25 along with xerographic component customer replaceable unit 40 that includes, but is not shown, the following components; drum photoreceptor, toner developer station, charging device, cleaning blade, and a toner waste sump.

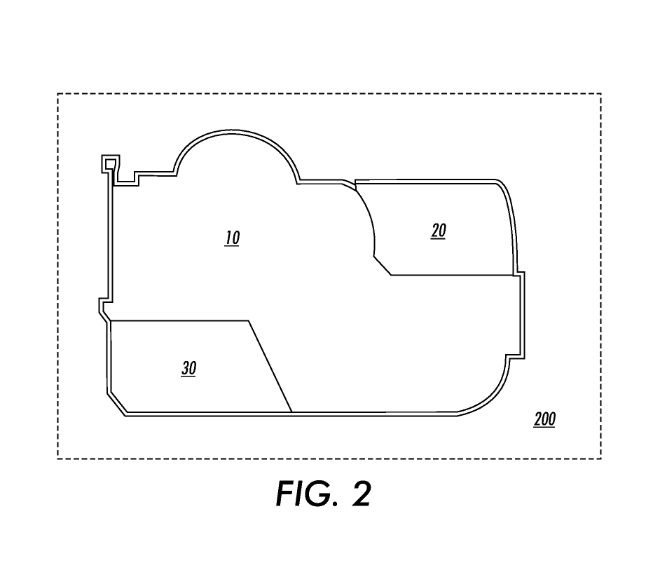

An example of another customer replaceable unit 200 is shown in FIG. 2. The customer replaceable unit 200 includes a xerographic component customer replaceable unit 10 that includes a small drum photoreceptor (not shown), a toner developer housing (not shown), a charging device (not shown), and a cleaning blade (not shown). The customer replaceable unit 200 also includes a detachable toner cartridge 20 that replaces the toner hopper 25 of the all-in-one customer replaceable unit 100 shown in FIG. 1. The customer replaceable unit 200 further includes a detachable waste cartridge 30 that replaces the waste sump of the all-in-one customer replaceable unit 100 shown in FIG. 1.

The life of the customer replaceable unit 200 is extended by a factor of two or more beyond that of the life of the customer replaceable unit 100 by refilling the toner supply through the use of the detachable toner cartridge 20. It is noted that the emptied toner cartridge 20 can also be reused as the waste cartridge 30. When the toner cartridge 20 is not interchangeable with the waste cartridge 30, replacement of waste cartridges 30 as well as toner cartridges 20 will be required. However, fewer waste cartridges 30 than toner cartridges 20 will be required because the majority of the toner will be consumed to produce the electrophotographic image. If only one or two extra toner cartridges are used, there may be no need for a replaceable waste cartridge.

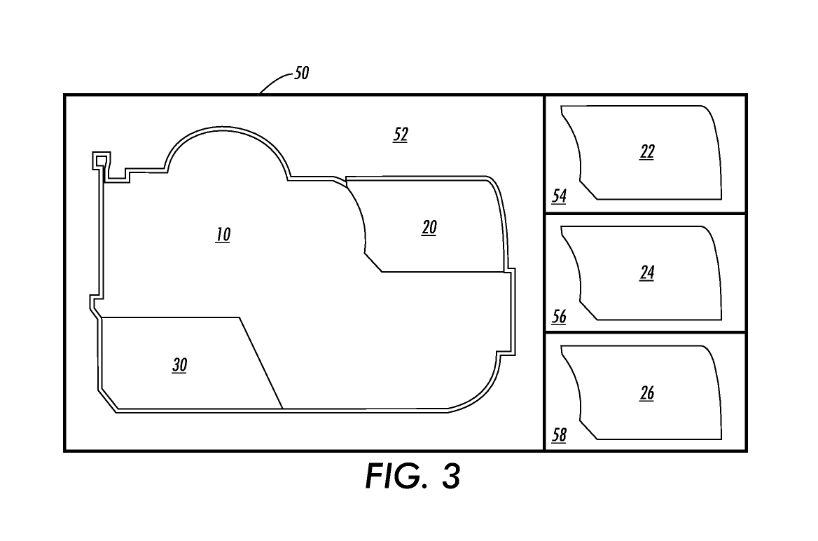

FIG. 3 is a schematic example of a customer replaceable unit kit 50. The customer replaceable unit kit 50 contains a customer replaceable unit 52 with xerographic component customer replaceable unit 10, four toner cartridges 20, 22, 24, and 26 (one toner cartridge 20 being attached to the xerographic component customer replaceable unit 10) and one waste cartridge 30 attached to the xerographic component customer replaceable unit 10. Each of the three additional toner cartridges 22, 24, and 26 resides in discrete compartments (54, 56, and 58) within the customer replaceable unit kit 50.

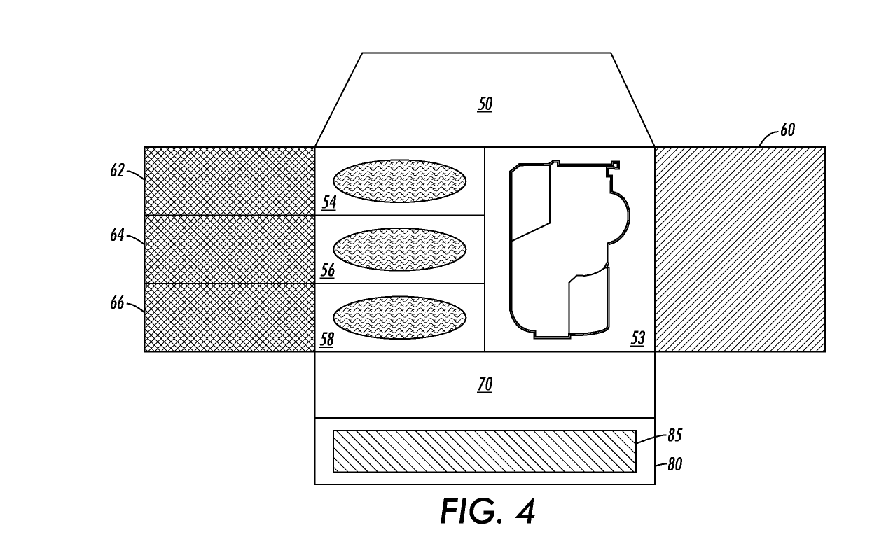

A more detailed drawing of the customer replaceable unit kit 50 is shown in FIG. 4. As shown in FIG. 4, the customer replaceable unit kit 50 has a compartment 53 that contains a customer replaceable unit wherein the customer replaceable unit includes a xerographic component customer replaceable unit, one toner cartridge attached to the xerographic component customer replaceable unit, and one waste cartridge attached to the xerographic component customer replaceable unit. The customer replaceable unit kit 50 also has separate compartments (54, 56, and 58) containing toner cartridges. The toner cartridges reside in separate compartments (54, 56, and 58) in the customer replaceable unit kit 50. It is noted that the toner cartridges may contain the same colored toner or may contain different colored toners.

Furthermore, each compartment (54, 56, and 58) has an optional compartment cover (62, 64, and 66). The associated compartment covers (62, 64, and 66) provide a mechanism to prevent the spillage of toner from the customer replaceable unit kit 50. As a used toner cartridge is placed in one of the compartments (54, 56, and 58), the compartment can be individually sealed by the associated compartment cover (62, 64, and 66) to prevent any detrimental toner leakage or migration.

It is noted that the compartments (54, 56, and 58) may include other mechanisms, such as a sealable bag or pouch, which is able to retain spilled toner from leaking from the compartments (54, 56, and 58). Moreover, it is noted that the compartment covers (62, 64, and 66) can be sealed with an adhesive tape covering. It is further noted that a plug or other similar seal, in combination with the compartment covers (62, 64, and 66) or alone, can be utilized to prevent toner spillage. Also, it is noted that the closing or sealing of the compartments (54, 56, and 58) can be utilized to indicate that the compartment contains a used cartridge. In addition, the compartment 53 containing the customer replaceable unit can be similarly sealed with compartment cover 60.

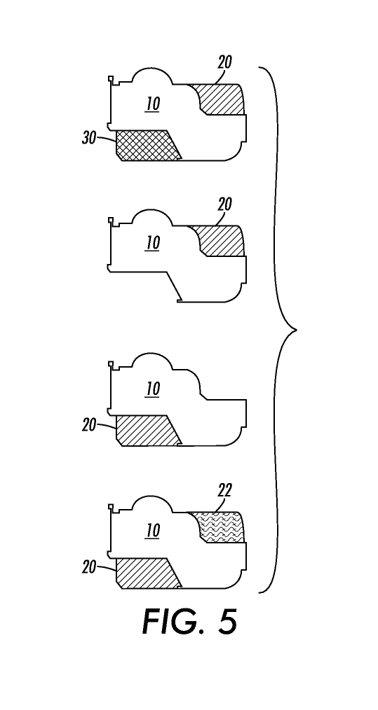

A method for replacing the waste and toner cartridges is graphically illustrated by FIG. 5. As the original toner cartridge 20 installed in the xerographic component customer replaceable unit 10 is emptied, the waste cartridge 30 is removed from the xerographic component customer replaceable unit 10. The empty toner cartridge 20 is attached to the xerographic component customer replaceable unit 10 to become the new waste toner cartridge for the xerographic component customer replaceable unit 10. One of the additional toner cartridges 22 in the customer replaceable unit kit is removed from its compartment and installed into the xerographic component customer replaceable unit 10 to become the new toner cartridge.

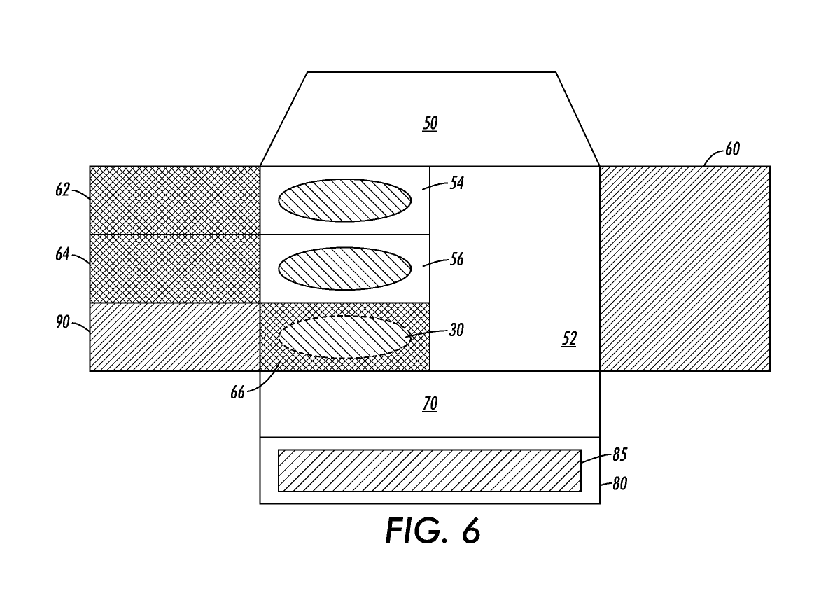

As indicated in FIG. 6, the waste cartridge 30 removed from the xerographic component customer replaceable unit is placed and sealed in a compartment that contained the removed toner cartridge 22. The compartment is sealed, as illustrated in FIG. 6, by compartment cover 66. It is noted that FIG. 6 also illustrates a cover 90 for the entire volume of customer replaceable unit kit 50 containing the toner cartridges.

When all the components of the customer replaceable unit kit 50 have been utilized such each compartment contains a used toner cartridge or xerographic component customer replaceable unit, a cover 70 can be used to seal the open section with a section 80 being used to secure the cover 70. The section 80 may contain an adhesive portion 85 to secure the section 80 to an outside portion of the customer replaceable unit kit 50. However, it is noted that section 80 may not contain an adhesive portion, but section 80 is tucked into the customer replaceable unit kit 50 so as to secure the cover 70. Once the customer replaceable unit kit 50 is properly sealed, the customer replaceable unit kit 50 shipped to a pre-determined destination for remanufacturing, recycling, and/or proper disposal.

It is noted that the customer replaceable unit kit can also be utilized for color reprographic machines. With respect to color reprographic machines, one type of color reprographic machine utilizes a separate photoreceptor; each photoreceptor having a corresponding raster output scanner (laser) and toner/developer housing, to generate the separate color toner images; and a common transfer belt to receive each separate color toner image and to transfer the combined color toner images to the recording medium.

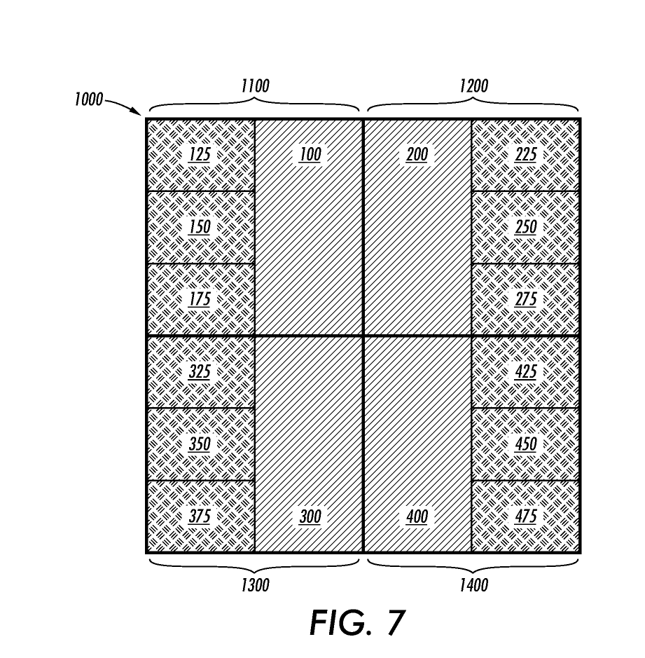

With respect to the color reprographic machine utilizing a transfer belt, the customer replaceable unit kit may be packaged in a variety of different ways. As illustrated in FIG. 7, the customer replaceable unit kit 1000 may include a multiple number of color specific customer replaceable unit kits (1100, 1200, 1300, and 1400), as delineated with the heavy lines in FIG. 7. Each color specific customer replaceable unit kit (1100, 1200, 1300, and 1400) includes a compartment (100, 200, 300, and 400) that contains a color specific xerographic component customer replaceable unit (not shown). Each color specific customer replaceable unit kit (1100, 1200, 1300, and 1400) also has separate compartments (125, 150, 175, 225, 250, 275, 325, 350, 375, 425, 450, and 475) that contain color specific toner cartridges (not shown).

For example, as illustrated in FIG. 7, the color specific customer replaceable unit kit 1100 may include compartment 100 that contains a xerographic component customer replaceable unit (not shown) corresponding to black toner. Moreover, the color specific customer replaceable unit kit 1100 may include compartments (125, 150, and 175) that contain color specific toner cartridges (not shown) corresponding to black toner.

Moreover, as illustrated in FIG. 7, the color specific customer replaceable unit kit 1200 may include compartment 200 that contains a xerographic component customer replaceable unit (not shown) corresponding to cyan toner. Moreover, the color specific customer replaceable unit kit 1200 may include compartments (225, 250, and 275) that contain color specific toner cartridges (not shown) corresponding to cyan toner.

Furthermore, as illustrated in FIG. 7, the color specific customer replaceable unit kit 1300 may include compartment 300 that contains a xerographic component customer replaceable unit (not shown) corresponding to magenta toner. Moreover, the color specific customer replaceable unit kit 1300 may include compartments (325, 350, and 375) that contain color specific toner cartridges (not shown) corresponding to magenta toner.

Also, as illustrated in FIG. 7, the color specific customer replaceable unit kit 1400 may include compartment 400 that contains a xerographic component customer replaceable unit (not shown) corresponding to yellow toner. Moreover, the color specific customer replaceable unit kit 1400 may include compartments (425, 450, and 475) that contain color specific toner cartridges (not shown) corresponding to yellow toner.

As noted above, each of the color specific customer replaceable unit kits (1100, 1200, 1300, and 1400) may be packaged separated or as a single customer replaceable unit kit 1000, as illustrated in FIG. 7. It is noted that the single replaceable unit kit 1000 may include fewer or more color specific customer replaceable unit kits, depending on the requirement of the color reprographic machine; such as, a process color machine may only require cyan, magenta, and yellow, a highlight machine may only require black and a second color, and a high fidelity machine may require black, cyan, magenta, yellow, and additional colors.

Furthermore, as described above, each compartment has an optional compartment cover. The associated compartment covers provide a mechanism to prevent the spillage of the color specific toner from the color specific customer replaceable unit kit. As a used color specific toner cartridge is placed in one of the compartments, the compartment can be individually sealed by the associated compartment cover to prevent any detrimental color specific toner leakage or migration.

It is noted that the compartments may include other mechanisms, such as a sealable bag or pouch, which is able to retain spilled color specific toner from leaking from the compartments. Moreover, it is noted that the compartment covers can be sealed with an adhesive tape covering. It is further noted that a plug or other similar seal, in combination with the compartment covers or alone, can be utilized to prevent color specific toner spillage. Also, it is noted that the closing or sealing of the compartments can be utilized to indicate that the compartment contains a used color specific toner cartridge. In addition, the compartment containing the color specific customer replaceable unit can be similarly sealed with a compartment cover. It is noted that a cover for color specific customer replaceable unit kit containing the color specific toner cartridges can be used to seal the entire kit.

When all the components of the color specific customer replaceable unit kit have been utilized such that each compartment contains a used color specific toner cartridge or color specific xerographic component customer replaceable unit, a cover can be used to seal the open section with a securing section being used to secure the cover. The securing section may contain an adhesive portion to secure the securing section to an outside portion of the color specific customer replaceable unit kit. However, it is noted that the securing section may not contain an adhesive portion, but the securing section is tucked into the color specific customer replaceable unit kit so as to secure the cover. Once the color specific customer replaceable unit kit is properly sealed, the color specific customer replaceable unit kit can be shipped to a pre-determined destination for remanufacturing, recycling, and/or proper disposal.

Another type of color reprographic machine, an image-on-image color reprographic machine, utilizes a common photoreceptor and common raster output scanner (laser). The image-on-image color reprographic machine includes a toner/developer housing for each color toner being utilized by the machine.

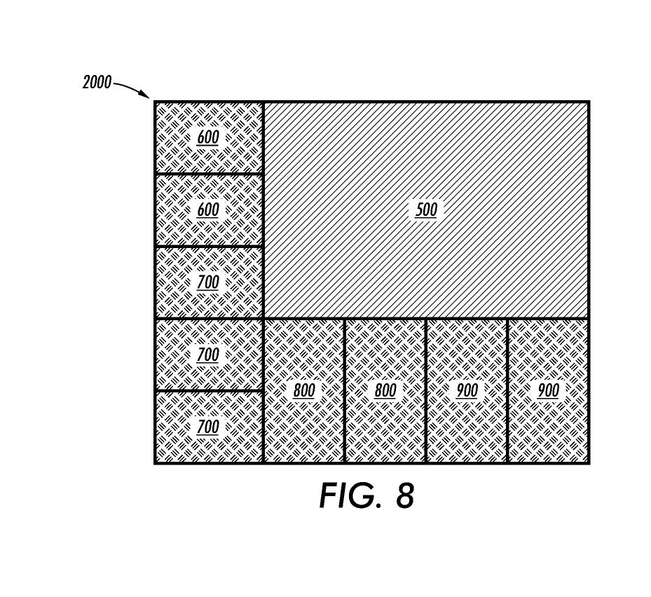

With respect to the image-on-image color reprographic machine, the image-on-image customer replaceable unit kit may be packaged in a variety of different ways. As illustrated in FIG. 8, the customer replaceable unit kit 2000 may include a compartment (500) that contains a xerographic component customer replaceable unit (not shown). The customer replaceable unit kit 2000 also has separate compartments (600, 700, 800, and 900) that contain color specific toner cartridges (not shown).

For example, as illustrated in FIG. 8, the compartments 600 may include color specific toner cartridges (not shown) corresponding to cyan toner. Moreover, as illustrated in FIG. 8, the compartments 700 may include color specific toner cartridges (not shown) corresponding to black toner.

Furthermore, as illustrated in FIG. 8, the compartments 800 may include color specific toner cartridges (not shown) corresponding to magenta toner. Also, as illustrated in FIG. 8, the compartments 900 may include color specific toner cartridges (not shown) corresponding to yellow toner.

It is noted that, in this illustrated example, the number of compartments for black toner is greater than the number for the other toners because it is assumed that a greater amount of black toner is consumed per printed page than the other toners.

It is noted that the single replaceable unit kit 2000 may include fewer or more color specific customer replaceable unit kits, depending on the requirement of the color reprographic machine; such as, a process color machine may only require cyan, magenta, and yellow, a highlight machine may only require black and a second color, and a high fidelity machine may require black, cyan, magenta, yellow, and additional colors.

Furthermore, each compartment has an optional compartment cover. The associated compartment covers provide a mechanism to prevent the spillage of toner from the image-on-image customer replaceable unit kit. As a used toner cartridge is placed in one of the compartments, the compartment can be individually sealed by the associated compartment cover to prevent any detrimental toner leakage or migration.

It is noted that the compartments may include other mechanisms, such as a sealable bag or pouch, which is able to retain spilled toner from leaking from the compartments. Moreover, it is noted that the compartment covers can be sealed with an adhesive tape covering. It is further noted that a plug or other similar seal, in combination with the compartment covers or alone, can be utilized to prevent toner spillage. Also, it is noted that the closing or sealing of the compartments can be utilized to indicate that the compartment contains a used cartridge. It is noted that a cover for the image-on-image customer replaceable unit kit containing the color toner cartridges can be used to seal the entire kit.

When all the components of the image-on-image customer replaceable unit kit have been utilized such that each compartment contains a used color toner cartridge or xerographic component customer replaceable unit, a cover can be used to seal the open section with a securing section being used to secure the cover. The securing section may contain an adhesive portion to secure the securing section to an outside portion of the color specific customer replaceable unit kit. However, it is noted that the securing section may not contain an adhesive portion, but the securing section is tucked into the image-on-image customer replaceable unit kit so as to secure the cover. Once the image-on-image customer replaceable unit kit is properly sealed, the image-on-image customer replaceable unit kit can be shipped to a pre-determined destination for remanufacturing, recycling, and/or proper disposal.

In summary, the customer replaceable unit kit will contain a customer replaceable unit having a xerographic component customer replaceable unit already loaded with toner and/or waste cartridges and one or more additional toner cartridges to extend the life of xerographic component customer replaceable unit. The customer replaceable unit kit allows a customer to remove and replace new and used toner cartridges with ease and no spillage. The customer replaceable unit kit contains compartments that store and seal used cartridges as the additional toner cartridges are removed from the customer replaceable unit kit. The customer can ship the depleted customer replaceable unit kit to a predetermined destination for remanufacturing, recycling, and/or proper disposal.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A kit of consumable units, comprising;
a container having a plurality of compartments therein;
a first consumable unit contained within one of said plurality of compartments;
second consumable units contained within a remainder of said plurality of compartments; and
a plurality of covers to seal said plurality of compartments; and
said first consumable unit having a life cycle substantially equal to a sum of life cycles of said second consumable units.

2. The kit as claimed in claim 1, wherein each compartment is sealed individually by one of said plurality of covers.

3. The kit as claimed in claim 2, wherein said plurality of compartments is sealed by a discrete cover that overlays said plurality of covers.

4. The kit as claimed in claim 3, wherein said discrete cover has an adhesive material thereon.

5. The kit as claimed in claim 1, wherein each of said plurality of covers has an adhesive material thereon.

6. The kit as claimed in claim 1, wherein each of said plurality of covers indicates, when sealing a compartment, that the consumable unit therein is depleted.

7. The kit as claimed in claim 1, wherein each of second consumable units contains a same colored toner.

8. The kit as claimed in claim 1, further including an area indicating a predetermined return destination.

9. A kit of xerographic consumable units, comprising;
a container having a plurality of compartments therein;
a first xerographic consumable unit contained within one of said plurality of compartments;
second xerographic consumable units contained within a remainder of said plurality of compartments; and
a plurality of covers to seal said plurality of compartments; and
said first consumable unit having a life cycle substantially equal to a sum of the life cycles of said second consumable units.

10. The kit as claimed in claim 9, wherein each compartment is sealed individually by one of said plurality of covers.

11. The kit as claimed in claim 10, wherein said plurality of compartments is sealed by a discrete cover that overlays said plurality of covers.

12. The kit as claimed in claim 11, wherein said discrete cover has an adhesive material thereon.

13. The kit as claimed in claim 9, wherein each of said plurality of covers has an adhesive material thereon.

14. The kit as claimed in claim 9, wherein each of second xerographic consumable units contains a same colored toner.

15. A kit of xerographic consumable units, comprising;
a container having a plurality of compartments therein;
a first xerographic consumable unit contained within one of said plurality of compartments;
second xerographic consumable units contained within a first predetermined number of a remainder of said plurality of compartments;
third xerographic consumable units contained within a second predetermined number of a remainder of said plurality of compartments;
fourth xerographic consumable units contained within a third predetermined number of a remainder of said plurality of compartments; and
a plurality of covers to seal said plurality of compartments; and
said first xerographic consumable unit having a life cycle substantially equal to a sum of life cycles of said second xerographic consumable units.

16. The kit as claimed in claim 15, wherein each compartment is sealed individually by one of said plurality of covers.

17. The kit as claimed in claim 15, wherein said first xerographic consumable unit has a life cycle substantially equal to a sum of life cycles of said third xerographic consumable units.

18. The kit as claimed in claim 15, wherein said first xerographic consumable unit has a life cycle substantially equal to a sum of life cycles of said fourth xerographic consumable units.

19. The kit as claimed in claim 15, further comprising:
fifth xerographic consumable units contained within a fourth predetermined number of a remainder of said plurality of compartments;
said first xerographic consumable unit has a life cycle substantially equal to a sum of life cycles of said fifth xerographic consumable units.

20. The kit as claimed in claim 15, wherein said first predetermined number is not equal to said second predetermined number.
